(19) United States
(12) Patent Application Publication
(10) Pub. No.: US 2006/0020354 A1
(43) Pub. Date: Jan. 26, 2006

(54) Digital home audio system

(76) Inventor: Joseph Ernest Lorkovic, Oceanside, CA (US)

Correspondence Address: JOSEPH LORKOVIC, 3747-40 VISTA CAMPANA SOUTH, OCEANSIDE, CA, 92057, US

(21) Appl. No.: 11/182,938

(22) Filed: Jul. 11, 2005

Related U.S. Application Data
(60) Provisional application No. 60/591,220, filed on Jul. 26, 2004.

(51) Int. Cl. G06F 17/00

(52) U.S. Cl. 700/94

(57) ABSTRACT

The system is dependent on a Home Theater PC, otherwise known as a HTPC or a standard PC or other computer system such as an Apple/Macintosh or Set-Top-Box. It is a combination audio control and audio transport system for sound output from a computer. The system uses the existing building power lines to transport digital audio to speaker system elements. Each element is a standalone combination of a home power line digital signal transceiver, digital amplifier and one or more actual speakers in a single unit. The preferable embodiment is for each element to cover only a single sound aspect such as High, Mid, or Low frequencies. The elements are daisy chained electrically and mechanically locked to each other as desired to build any size speaker unit at a given location. The computer receives registration of the elements by scanning the network and the user configures the plug location elements to respond to an audio channel. Audio channels are grouped into audio profiles for routing of application output to grouped speaker sets referred to as audio profiles.

### CROSS-REFERENCE TO RELATED APPLICATIONS

THIS APPLICATION CLAIMS THE BENEFIT OF PROVISIONAL PATENT APPLICATION SER. No. 60/591,220 FILED Jul. 26, 2004

### FEDERALLY SPONSORED RESEARCH

Not Applicable

### SEQUENCE LISTING OR PROGRAM

Not Applicable

### FIELD OF INVENTION

The present invention is generally related to computer audio, in particular, to a home theater personal computer system that is, in turn, coupled to any local area network in support of communications with speaker system elements.

### BACKGROUND ART

Over the last few years, there has been a shift to digital and more specifically computer digital content. The analog audio output from a computer has negative factors in regard to high fidelity sound. Mainly digital to analog conversion within the confines of a computer enclosure is a negative factor affecting the quality of the actual sound. The computer can process digital output extremely well, the processing at the sound card level to an analog signal is undesirable.

Beyond the analog output issue another factor is the amplification of the analog signal. The new digital amplifiers now available process a digital signal to provide an amplified analog output that can drive a speaker efficiently and with less power consumption. These digital amplifiers also are much more efficient and produce far less heat.

Another issue is matching a traditional analog signal amplifier with a given speaker system. The considerations such as watts, ohms, number of channels desired and the number of speakers purchased for the original configuration. Too few or too small speakers run the risk of blow-out and too many or too much load may damage the amplifier and so on.

The future, I believe revolves around the computer as the central entertainment system of the home. Less clutter of wires, connectors, and components is highly desirable. As the computer becomes the All-In-One component for home entertainment and many other functions the issue of the fidelity of the sound output has become a critical issue and a missing link in the evolution.

Consequently, there is a present and future need to resolve this computer audio deficiency and deliver on the promise of the digital home.

### BRIEF DESCRIPTION OF THE DRAWINGS

All figures are general in nature and in accordance with one embodiment of the present invention.

FIG. 1 is computer unit with 5 items; representing an example of one embodiment of the present invention.

FIG. 2 is a speaker element with 7 items; representing an example of one embodiment of the present invention.

### SUMMARY OF CERTAIN EMBODIMENTS OF THE INVENTION

Thus, at least one embodiment of the present invention is to provide the best possible audio system and remove the traditional configuration and expandability problems common in the traditional home audio system. In essence the present invention removes all PC based audio disadvantages that the PC has been plagued with and provides a means to deliver high quality audio of any type throughout the home. The software that controls the system from the computer may provide any number of options for control such as advanced equalization, volume and application to speaker routing. When used in conjunction with the control and display system as described in patent application “Digital Home Control System”, Ser. No. 20040117835 FILED Sep. 22, 2003, then other sound routing and computer control functionality becomes an apparent need as the remote unit described in the referenced invention maybe moved to multiple locations. In the current invention an audio channel is divided into frequency ranges such as High, Mid, and Low referred to as element channels. Implementation could have more or less breakdown such as only High and Low frequency ranges or no breakdown of frequencies for some units on the audio network as determined by a discovery process that registers units on the network along with the frequency range the unit processes. Speaker elements directly relate to frequency ranges. For example the traditional analog stereo system defines 2 channels, left and right. The present invention splits stereo into 6 distinct outputs, left high, mid, and low range and right high, mid, and low range element channels. Thus, this system breaks down traditional 6 channel surround sound into 16 distinct outputs. 5 traditional channels with high, mid, and low ranges are 15 element channels plus one low range channel. The breaking down of the traditional audio high, mid, and low frequencies provides more control over the sound system and greater expandability while also providing the benefits of an active crossover network. The use of the power lines to provide the sound signal, and the power source provides optimal placement, and expandability to meet any need, and other transports such as wireless networking maybe implemented as an additional transport.

The traditional speaker typically consists of multiple individual speakers in an encasement. The present invention provides only speaker elements of a particular frequency range to an encasement. Thus the equivalent of a traditional speaker system containing individual speakers for high, mid, and low range in the present invention would encompass three separate encasements. Each encasement is referred to as a speaker element. The speaker elements maybe stacked one on another or physically connected to each other with lock in place hardware to form a single physical unit. The speaker elements electrically connect to each other by daisy chaining power cords that in turn provide a connection to the audio network. Each speaker element is self contained, not reliant on anything other than the power cord connection, although they may also use a wireless network connection. Logical channels are setup using any combination of speaker elements desired on that channel. For example, setup of a 6 channel surround sound system could implement left, right, front, and rear using mid and high speaker elements and use a single low frequency speaker element for the bass channel and a single mid speaker elements for the center channel. The system could be upgraded at anytime adding additional speaker elements as desired. An upgrade maybe implemented to provide more of any element required or simply to provide more of all elements to provide more over all volume. In conjunction with the components described other ultrasonic directional speaker units maybe implemented or the described system maybe based solely on ultrasonic units. The system may also incorporate sound sensors that provide feedback to the computer for acoustic tuning. Audio profiles consisting of grouped speakers maybe setup within the controlling software in the computer to output an application's audio to a defined set of speakers.

### DETAILED DESCRIPTION OF CERTAIN EMBODIMENTS OF THE INVENTION

The system at the source computer is based on standard audio routing over any network protocol. Audio channels are divided into separate low, mid, and high frequencies that are in turn routed as a mono source of only the frequency the speaker element is designed to output. If this is not implemented a crossover filter maybe implemented at the speaker element, however, the active crossover and separation of a channel's frequencies within the computer has many advantages such as precision control of a speaker element and other benefits. As an example the amplification of only a single frequency range on a logical audio channel such as left rear channel mid frequency or high frequency center channel. Enabling this precession control provides adjustments beyond the common equalizer. Efficiency is achieved because only the data that a speaker element will use is processed by the speaker element. The system implements an identification and control system of present speaker elements. In one such embodiment Universal Plug and Play is used for this identification and control system.

Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein. The present example of the invention may comprise an apparatus and method for effectively implementing a digital home audio network, and may preferably include multiple speaker units that in turn form logical audio channels. Said audio channels maybe further grouped into audio profiles within the controlling software on the computer to route application audio to select speakers.

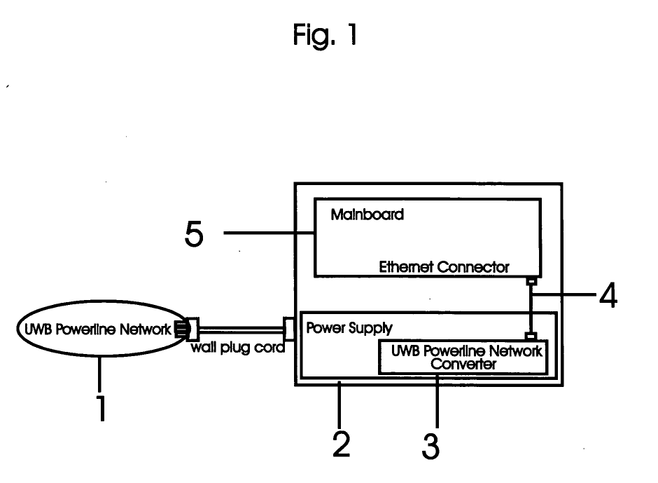

The preferred power line based system configuration is implemented at the source computer based on 1 Universal Plug and Play technologies operating over a power line based Ultra Wide Band implementation. The computer system is ideally equipped with the 3 power line network adaptor built into the 2 power supply of the computer system or a power line network adaptor and power supply connection and mounting system. The Ethernet signal is 4 cable connected to the 5 mainboard in accordance with the present invention is shown in FIG. 1.

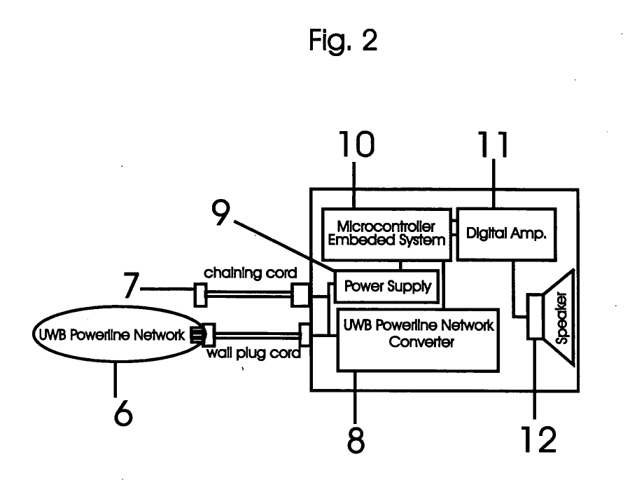

Speaker elements are based on 6 Plug and Play technologies operating over a power line based Ultra Wide Band transport. Audio packets are present on the 6 Network and processed by the 8 Ultra Wide Band transport to Ethernet converter that in turn provides Ethernet data to the 10 embedded system that processes the packets addressed to this unit. The digital audio signal is provided to the 11 digital amplifier that provides an analog signal to the 12 speaker in accordance with the present invention is shown in FIG. 2.

What is claimed is:

1. A computer based component audio system comprising:
a) individual audio frequency based encasements;
b) said encasements daisy chained electrically at channel locations;
c) said encasements having a transceiver and supporting circuits for operation with, said component audio system having:
i) logical channel groupings;
ii) physical channel groupings.

2) Computer based component audio system of claim 1, wherein profile groupings of logical channels for computer application audio output routing is implemented.

3) Computer based component audio system of claim 1, wherein computer based active crossover network is implemented.

4) Computer based component audio system of claim 1, having a digital network transport.

5. A speaker system based on frequency based encasements:
a) said encasements located together to form all the required audio spectrum for a given audio channel.

6. A audio network comprising:
a) audio components grouped into channels and profiles;
b) said audio profiles defining logical audio output groupings.
